(19) United States
(12) Patent Application Publication
(10) Pub. No.: US 2004/0144621 A1
(43) Pub. Date: Jul. 29, 2004

(54) Method and conveyor for conveying articles

(75) Inventor: Mario Spatafora, Bologna (IT)

Correspondence Address: William R. Evans, Ladas & Parry, 26 West 61 Street, New York, NY, 10023, US

(73) Assignee: G.D SOCIETA' PER AZIONI

(21) Appl. No.: 10/657,749

(22) Filed: Sep. 8, 2003

(30) Foreign Application Priority Data
Sep. 10, 2002 (IT) BO2002A000570

(51) Int. Cl. B65G 29/00

(52) U.S. Cl. 198/463.1

(57) ABSTRACT

A method of conveying articles provides for feeding an article to a pocket travelling along a conveying path; gripping the article by means of suction holes located along a plate of the pocket; feeding the article and the pocket along the path; releasing and pushing the article against a locating member of the pocket as the article and the pocket are advanced; and gripping the article to the plate by means of the suction holes.

The present invention relates to a method of conveying articles.

More specifically, the present invention relates to a method of conveying blanks by which to produce packets of cigarettes, to which the present invention refers purely by way of example.

### BACKGROUND OF THE INVENTION

Blanks are normally supplied successively to respective pockets on a packing machine conveyor, and are fed along a given path, along which, they are paired with respective groups of cigarettes wrapped beforehand in sheets of foil. Once paired with a respective group, the blank is folded about the group by folding members on the packing machine.

The blank is made of cardboard, and comprises tabs and flaps defined by cuts and crease lines. The crease lines are defined by incisions made in the cardboard, and which act as hinges about which the tabs and flaps are folded.

It is essential, therefore, that each blank be set to a given position with respect to the group and the folding members to prevent the group from being placed on the crease lines, or the folding members from folding portions of the blank not meant to be folded.

### SUMMARY OF THE INVENTION

It is an object of the present invention to provide a method of conveying articles, designed to eliminate the aforementioned drawbacks, and which provides for positioning each article correctly with respect to the pocket.

According to the present invention, there is provided a method of conveying articles, comprising the steps of feeding an article to a pocket travelling along a given path; retaining said article by gripping means associated with said pocket; and feeding the article along said path in a given direction by means of said pocket; the method being characterized by releasing said article from said gripping means, and pushing the article against a locating member of said pocket as said article is advanced.

The present invention also relates to a conveyor for conveying articles.

According to the present invention, there is provided a conveyor for conveying articles, the conveyor comprising a pocket movable in a direction along a given path, and gripping means associated with said pocket to retain said article; and the conveyor being characterized by comprising folding devices located along the path and cooperating with said gripping means and with a locating member associated with said pocket.

### BRIEF DESCRIPTION OF THE DRAWINGS

A non-limiting embodiment of the present invention will be described by way of example with reference to the accompanying drawings, in which:

FIG. 1 shows a schematic side view of a conveyor for implementing the present invention;

FIG. 2 shows a larger-scale view in perspective, with parts in section and parts removed for clarity, of a detail of the FIG. 1 conveyor;

FIG. 3 shows a plan view, with parts in section and parts removed for clarity, of the FIG. 2 detail;

FIGS. 4, 5 and 6 show side views, with parts in section and parts removed for clarity, of the FIG. 1 conveyor at different operating steps;

FIG. 7 shows a view in perspective of an article conveyed by the FIG. 1 conveyor.

### DETAILED DESCRIPTION OF THE INVENTION

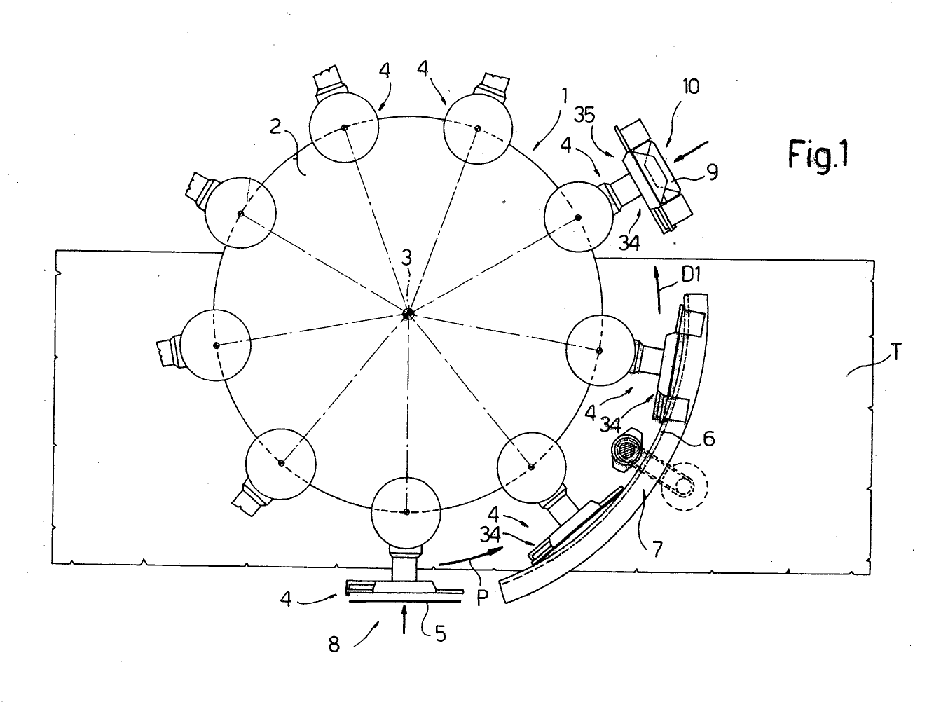

Number 1 in FIG. 1 indicates as a whole a conveyor of a packing machine (not shown) for packing cigarettes (not shown).

Conveyor 1 is supported by a frame T, and comprises a drum 2 rotating about an axis 3; a number of gripping members 4 equally spaced about axis 3 (perpendicular to the FIG. 1 plane) and movable in a direction D1 along a conveying path P of cardboard blanks 5; a guide 6 parallel to a portion of path P; and folding members 7 located along path P at guide 6. Each blank 5 is fed to a gripping member 4 of conveyor 1 at a feed station 8 located upstream from guide 6 in direction D1, and is paired with a group 9 of cigarettes, wrapped beforehand in a sheet of foil, at a pairing station 10 located downstream from guide 6 in direction D1.

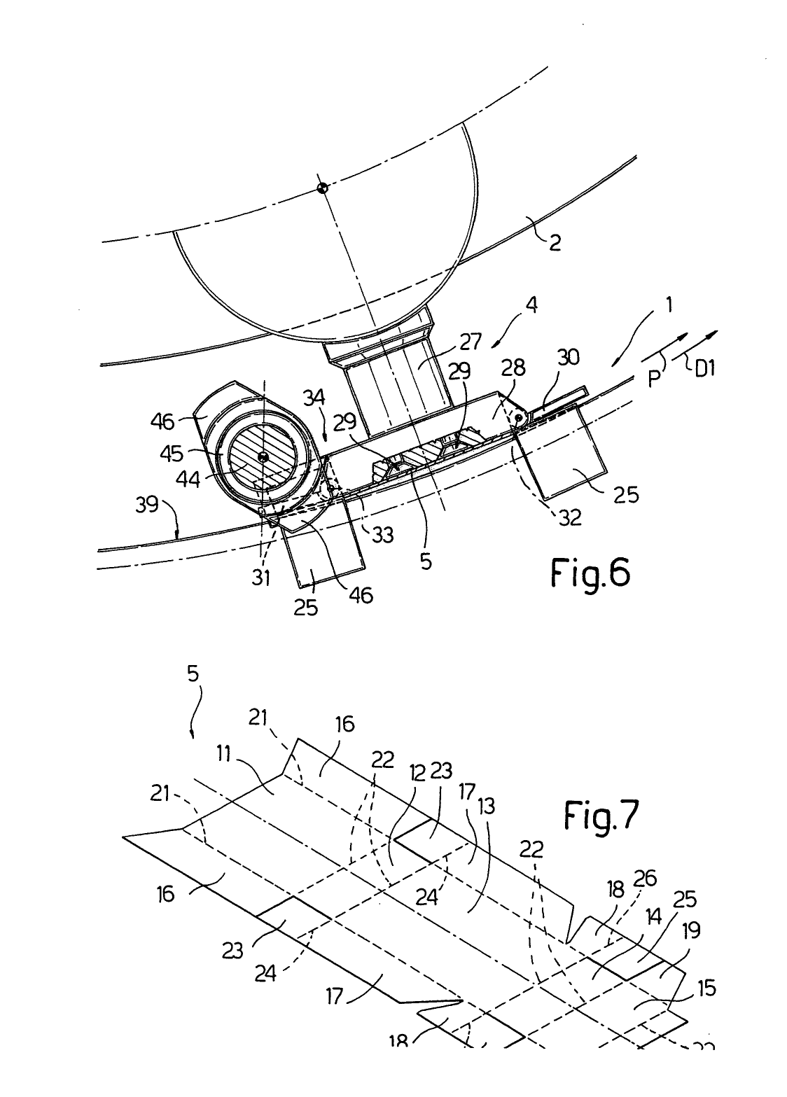

With reference to FIG. 7, blank 5, when flat, extends along and is symmetrical with respect to an axis A, and comprises a front panel 11, a bottom panel 12, a rear panel 13, a top panel 14; and a front lid panel 15. Tabs 16, 17, 18, 19 and 20 extend from panels 11, 13 and 15; panels 11-15 and tabs 16-20 are bounded by crease lines 21 parallel to axis A, and by crease lines 22 perpendicular to axis A; and a flap 23 extends from each tab 17, and is bounded with respect to tab 17 by a crease line 24. Similarly, a flap 25 extends from each tab 18, and is bounded with respect to tab 18 by a crease line 26. Crease lines 21, 22, 24 and 26 are substantially incisions made in the cardboard of blank 5, and serve to fold panels 11-15, tabs 16-20, and flaps 23 and 25 easily with respect to adjacent panels 11-15 and/or tabs 17 and 18. In other words, crease lines 21, 22, 24 and 26 act as hinges.

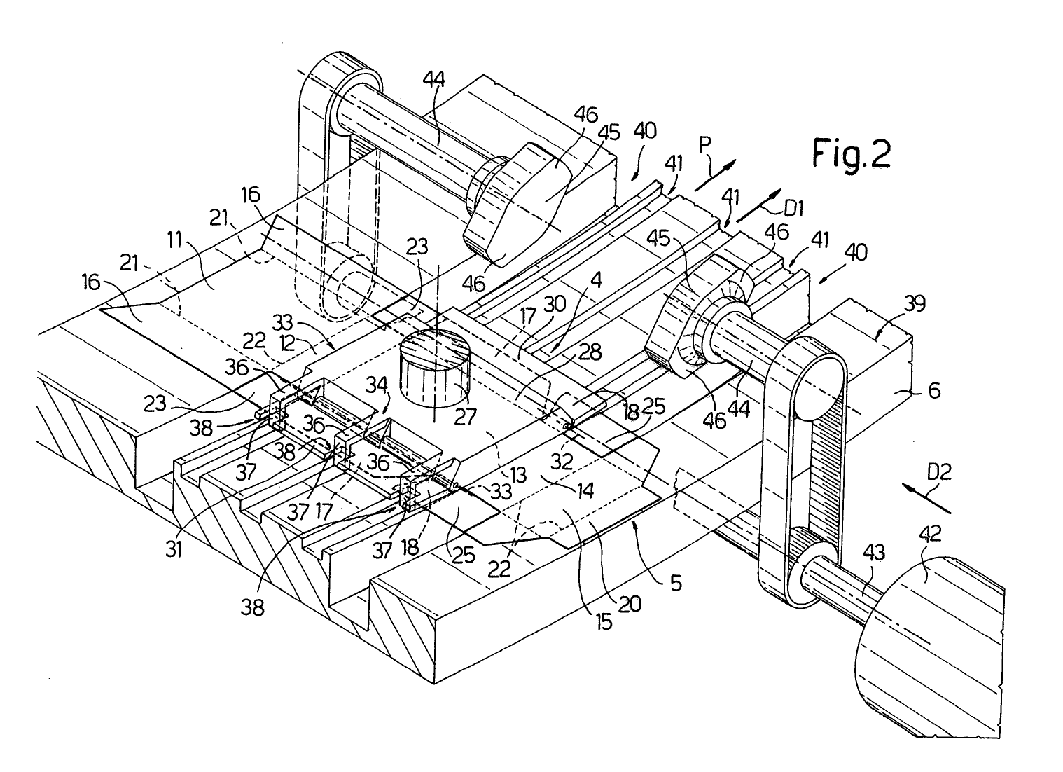

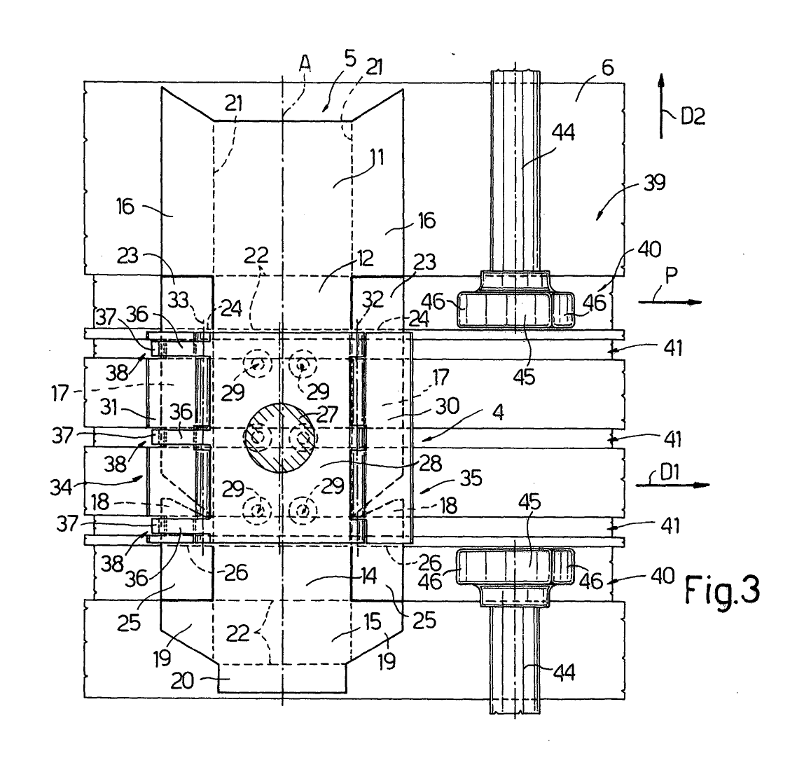

With reference to FIGS. 2 and 3, each gripping member 4 comprises a rod 27 connected to drum 2; a plate 28 fitted to rod 27 and having suction holes 29; two folding devices 30 and 31 hinged to plate 28 about respective axes 32 and 33 parallel to axis 3; and a locating member 34 integral with plate 28. Gripping member 4 comprises known mechanisms, not shown, for rotating the two folding devices 30 and 31 about respective axes 32 and 33. That is, member 4 comprises a variable-configuration pocket 35 defined by plate 28 and the two folding devices 30 and 31, which can be positioned substantially coplanar with plate 28, perpendicular to plate 28, or in intermediate positions between the coplanar and perpendicular positions.

Locating member 34 comprises three teeth 36 located downstream from plate 28 in direction D1, and each having a free end 37 bent outwards of drum 2 and engaging a respective opening 38 in folding device 31.

Guide 6 is in the form a cylindrical shell sector, which has an inner face 39 facing drum 2. Two grooves 40 are formed along face 39, extend parallel to path P, and provide for housing flaps 23 and 25 folded with respect to the rest of blank 5, and part of folding member 7; and three grooves 41 are also formed along face 39, extend parallel to path P, between grooves 40, and provide for housing ends 37 of teeth 36. That is, face 39 faces plates 28 of gripping members 4 travelling along guide 6.

With reference to FIG. 2, folding member 7 comprises a drive member 42; a shaft 43 parallel to axis 3 and rotated by drive member 42; and two shafts 44 parallel to and rotated by shaft 43, and having a folding devices 45 having lobes 46 for squarely folding flaps 23 and 25. Each folding device 45 is located between guide 6 and drum 2, and is synchronized with pockets 35 so that each lobe 46 folds a respective flap 23 or 25.

In actual use, each blank 5 is fed to a respective pocket 35 at feed station 8, and is gripped by plate 28 by means of suction holes 29, as shown in FIG. 1. With reference to FIGS. 2 and 3, the blank 5 feed step comprises seating blank 5 inside the open pocket 35 with axis A of blank 5 substantially parallel to axis 3 of drum 2, with panel 13 on plate 28, and with tabs 17 and 18 at the two folding devices 30 and 31. Drum 2 is rotated continuously, and blank 5 is fed to pocket 35 without stopping gripping member 4 at feed station 8, so that blank 5 is positioned substantially accurately in a direction parallel to axis 3, but not so in travelling direction D1.

When pocket 35 faces guide 6, the suction through holes 29 is cut off, and blank 5 is kept along path P by guide 6 and is free to move with respect to pocket 35. One movement along path P may be induced by the drag of blank 5, so as to push blank 5 against ends 37 of teeth 36 of locating member 34. Since, however, the drag of blank 5 may not be enough to produce a sliding movement in direction D1 between blank 5 and pocket 35, blank 5 is conveyed without being retained by respective pocket 35 through the region occupied by folding member 7, which folds flaps 23 and 25.

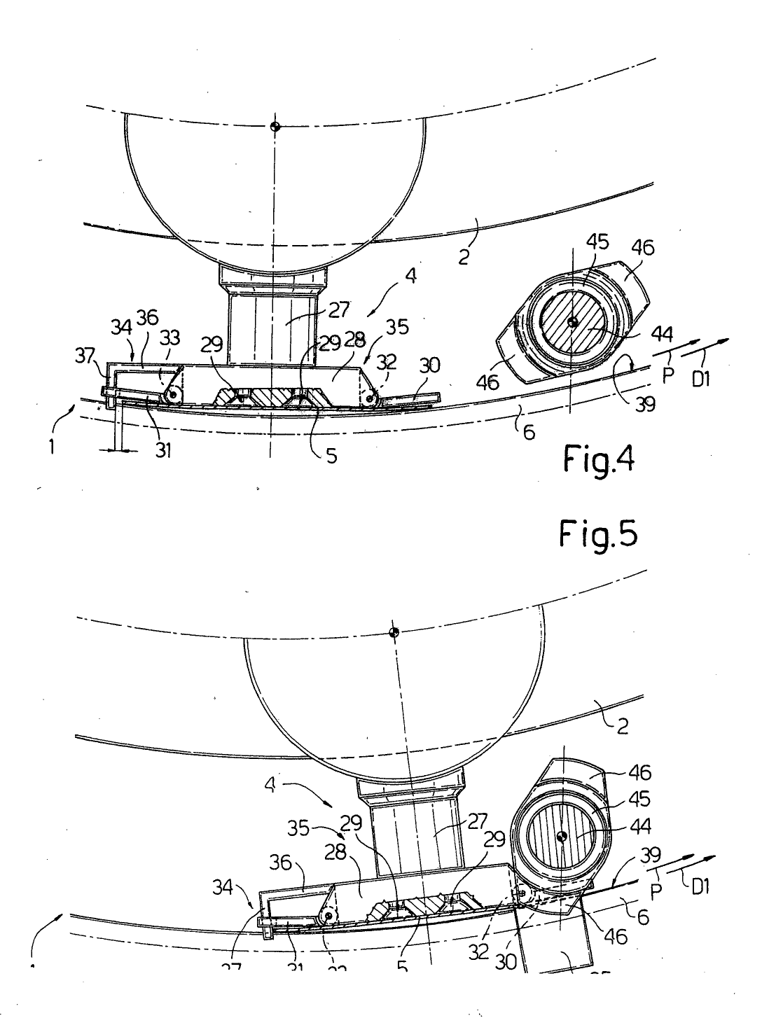

Flaps 23 and 25 total four in number, and comprise two front flaps 23 and 25, i.e. upstream from plate 28 in direction D1, and two rear flaps 23 and 25, i.e. downstream from plate 28 in direction D1. More specifically, and with reference to FIG. 4, lobes 46 are timed with front flaps 23 and 25 of a blank 5 theoretically positioned correctly. In FIG. 5, lobes 46 gradually come into contact with and begin folding front flaps 23 and 25 about lines 24 and 26. At this stage, even if blank 5 is still some distance from ends 37, i.e. is not positioned correctly inside pocket 35, blank 5 is pushed against ends 37 by lobes 46 as they begin folding front flaps 23 and 25.

Since both lobes 46 act simultaneously on the two front flaps 23 and 25, there is no danger of misalignment of axis A of blank 5 with respect to axis 3 of drum 2. Once the two front flaps 23 and 25 are folded, the suction through holes 29 is reactivated to grip blank 5 in the definitely correct position, so that lobes 46, as shown in FIG. 6, are timed with the two rear flaps 23 and 25, which are folded squarely with respect to the rest of blank 5.

Subsequently, a group 9 is paired with blank 5 at station 10, and tabs 17 and 18 are folded by folding devices 30 and 31, together with flaps 23 and 25 already folded squarely with respect to tabs 17 and 18. In addition to folding flaps 23 and 25, folding devices 45 therefore also act as contrasting members by which to push blank 5 against locating member 34.

1) A method of conveying articles, comprising the steps of feeding an article (5) to a pocket (35) travelling along a given path (P); retaining said article (5) by gripping means (28, 29) associated with said pocket (35); and feeding the article (5) along said path (P) in a given direction (D1) by means of said pocket (35); the method being characterized by releasing said article (5) from said gripping means (28, 29), and pushing the article (5) against a locating member (34) of said pocket (35) as said article (5) is advanced.

2) A method as claimed in claim 1, characterized by retaining the article (5) by means of said gripping means (28, 29) once the article (5) rests against said locating member (34).

3) A method as claimed in claim 1, characterized in that said locating member (34) is located downstream from the gripping means (28, 29) with respect to the feed direction (D1).

4) A method as claimed in claim 3, characterized by pushing said article (5) against said locating member (34) by means of push means (45) located along said path (P).

5) A method as claimed in claim 4, characterized in that said push means are folding devices (45).

6) A method as claimed in claim 5, characterized in that said articles are blanks (5); each blank (5) comprising panels (11, 12, 13, 14, 15), tabs (16, 17, 18, 19, 20) and flaps (23, 25).

7) A method as claimed in claim 6, characterized in that the tabs (16, 17, 18, 19, 20) are bounded with respect to the panels (11, 12, 13, 14, 15) by first crease lines (21, 22), and the flaps (23, 25) are bounded with respect to the tabs (17, 18) by second crease lines (24, 26); said second crease lines (24, 26) being substantially parallel to the feed direction (D1).

8) A method as claimed in claim 7, characterized in that the blank (5) has a longitudinal axis (A); the method conveying each blank (5) with its longitudinal axis (A) crosswise to the feed direction (D1).

9) A method as claimed in claim 7, characterized in that said blank (5) comprises a first pair of flaps (23, 25) upstream with respect to the respective pocket (35), and a second pair of flaps (23, 25) downstream with respect to the pocket (35); the method folding the first pair of flaps (23, 25) by means of said folding devices (45) when said blank (5) is released from said gripping means (28, 29).

10) A method as claimed in claim 9, characterized by folding the second pair of flaps (23, 25) by means of said folding devices (45) when the blank (5) is retained by said gripping means (28, 29).

11) A method as claimed in claim 1, characterized by feeding each article (5) between the respective pocket (35) and a guide (6), located along a portion of the path (P), when said gripping means (28, 29) are deactivated.

12) A conveyor for conveying articles (5), the conveyor comprising a pocket (35) movable in a direction (D1) along a given path (P), and gripping means (28, 29) associated with said pocket (35) to retain said article (5); and the conveyor being characterized by comprising folding devices (45) located along the path (P) and cooperating with said gripping means (28, 29) and with a locating member (34) associated with said pocket (35).

13) A conveyor as claimed in claim 12, characterized in that said locating member (34) is located downstream with respect to the gripping means (28, 29).

14) A conveyor as claimed in claim 13, characterized in that said locating member (34) comprises stop members (37) for said article (5).

15) A conveyor as claimed in claim 12, characterized in that said folding devices (45) are rotary folding devices (45) selectively positioned contacting said article (5).

16) A conveyor as claimed in claim 15, characterized in that said folding devices (45) rotate about an axis (44) perpendicular to said direction (D1).

17) A conveyor as claimed in claim 16, characterized in that said articles are blanks (5); each blank (5) comprising panels (11, 12, 13, 14, 15), tabs (16, 17, 18, 19, 20) and flaps (23, 25); said folding devices (45) folding said flaps (23, 25) with respect to the rest of the blank (5); and said gripping means (28, 29) comprising a plate (28) and suction holes (29) for retaining one (13) of said panels (11, 12, 13, 14, 15).

18) A conveyor as claimed in claim 17, characterized in that the tabs (16, 17, 18, 19, 20) are bounded with respect to the panels (11, 12, 13, 14, 15) by first crease lines (21, 22), and the flaps (23, 25) are bounded with respect to the tabs (17, 18) by second crease lines (24, 26); said pocket (35) retaining said blank (5) with said second crease lines (24, 26) substantially parallel to said direction (D1).

19) A conveyor as claimed in claim 18, characterized in that said blank (5) comprises a first pair of flaps (23, 25) upstream with respect to the respective pocket (35), and a second pair of flaps (23, 25) downstream with respect to the pocket (35); each folding device (45) comprising a first lobe (46) for folding a flap in the first pair of flaps (23, 25), and a second lobe (46) for folding a flap in the second pair of flaps (23, 25).

20) A conveyor as claimed in claim 12, characterized by comprising a guide (6) located along a portion of the path (P).

21) A conveyor as claimed in claim 20, characterized by comprising a drum (2) rotating about an axis (3) of rotation and having a number of gripping members (4) equally spaced about the axis (3) of rotation; each gripping member (4) having a said pocket (35).

22) A conveyor as claimed in claim 21, characterized in that said guide (6) comprises a face (39) facing said drum (2).

23) A conveyor as claimed in claim 22, characterized in that said folding devices (45) are located between the guide (6) and the drum (2).

24) A conveyor as claimed in claim 22, characterized in that said guide comprises first grooves (40) extending parallel to the path (P) along said face (39) and for housing the folded flaps (23, 25).

25) A conveyor as claimed in claim 22, characterized in that said guide (6) comprises second grooves (41) extending parallel to the path (P) and for partly housing the locating member (34).
